(19) United States
(12) Patent Application Publication
(10) Pub. No.: US 2011/0254979 A1
(43) Pub. Date: Oct. 20, 2011

(54) IMAGING APPARATUS, SIGNAL PROCESSING APPARATUS, AND PROGRAM

(75) Inventor: Mitsuhiro OKAZAKI, Saitama-shi (JP)

(73) Assignee: NIKON CORPORATION, TOKYO (JP)

(21) Appl. No.: 13/078,097

(22) Filed: Apr. 1, 2011

(30) Foreign Application Priority Data
Apr. 2, 2010 (JP) P2010-086117
Mar. 31, 2011 (JP) P2011-080377

(51) Int. Cl. H04N 5/76

(52) U.S. Cl. 348/231.4; 348/E05.024

(57) ABSTRACT

An imaging apparatus includes a microphone that converts a sound signal into an electrical signal, a detector that detects at least one of a sensor signal output from an operation sensor detecting an operation of an imaging unit that takes an optical image obtained by an optical unit and a control signal output from an operation unit that controls the operation of the imaging unit, a determination unit that determines a state of operation of the imaging unit based on at least one of the sensor signal and the control signal, a memory unit that stores a first electrical signal output from the microphone as a noise signal when a signal ratio of the first electrical signal and a second electrical signal is equal to or greater than a predetermined threshold value, and a noise reduction unit that reduces a noise of the electrical signal.

Priority is claimed on Japanese Patent Applications No. 2010-086117, filed Apr. 2, 2010, and No. 2011-080377, filed Mar. 31, 2011, the contents of which are incorporated herein by reference.

### BACKGROUND

1. Field of the Invention

The present invention generally relates to an imaging apparatus, a signal processing apparatus, and a program.

2. Description of the Related Art

Japanese Unexamined Patent Application, First Publication, No. 2004-080788 describes a camera that records sound signals (sound waves) including the motor noise of the camera or the like immediately after the power switch of the camera is turned on or instructions of the camera are input by an operator and makes adjustments of an adaptive filter for reducing the noise based on noises included in the recorded sound signals.

However, when the camera records the sound signals including the motor noise or the like, if other noises except the motor noise are also included in the sound signals, it may be difficult to reasonably extract the motor noise or the like from the sound signals. In this case, it may cause a problem that the noises cannot be reduced appropriately because an adjustment filter is not properly adjusted.

### SUMMARY

Accordingly, it is an object of some aspects of the present invention to provide an oscillating actuator drive unit, a lens barrel including the oscillating actuator drive unit, and an optical apparatus includes the oscillating actuator drive unit which reduces power consumption caused by the manufacturing fluctuation of the oscillating actuator.

In accordance with an aspect of the present invention, an imaging apparatus includes a microphone that converts a sound signal into an electrical signal; a detector that detects at least one of a sensor signal output from an operation sensor detecting an operation of an imaging unit that takes an optical image obtained by an optical unit and a control signal output from an operation unit that controls the operation of the imaging unit; a determination unit that determines a state of operation of the imaging unit based on at least one of the sensor signal and the control signal; a memory unit that stores a first electrical signal output from the microphone as a noise signal when a signal ratio of the first electrical signal and a second electrical signal is equal to or greater than a predetermined threshold value. The first electrical signal is a signal output from the microphone when the determination unit determines that the imaging unit is in operation. The second electrical signal is a signal output from the microphone when the determination unit determines that the imaging unit is not in operation. The imaging apparatus further includes a noise reduction unit that reduces a noise of the electrical signal output from the microphone using the noise signal stored in the memory unit.

In accordance with another aspect of the present invention, a signal processing apparatus includes a signal input unit that inputs at least one of a sensor signal output from a sensor that detects an operation of an imaging unit taking an image obtained by an optical unit of an imaging apparatus and a control signal output from a control unit that controls the operation of the imaging unit, and inputs a sound signal output from the imaging apparatus; a determination unit that determines a state of operation of the imaging unit using at least one of the sensor signal and the control signal; a memory unit that stores a first sound signal output from the microphone as a noise signal when a signal ratio of the first sound signal and a second sound signal is equal to or greater than a predetermined threshold value. The first sound signal is output from the microphone while the determination unit determines that the imaging unit is in operation. The second sound signal is output from the microphone while the determination unit determines that the imaging unit is not in operation. The signal processing apparatus further includes a noise reduction unit that reduces a noise of the sound signal input into the signal input unit using the noise signal stored in the memory unit.

In accordance with another aspect of the present invention, a computer-readable recording medium recording a program which causes a computer to execute instructions for processing signals, the program includes converting a sound signal into an electrical signal by use of a microphone; detecting at least one of a sensor signal output from an operation sensor detecting an operation of an imaging unit that takes an optical image obtained by an optical unit and a control signal output from an operation unit that controls the operation of the imaging unit by use of a detector; determining a state of operation of the imaging unit based on at least one of the sensor signal and the control signal by use of a determination unit; storing a first electrical signal output from the microphone as a noise signal when a signal ratio of the first electrical signal and a second electrical signal is equal to or greater than a predetermined threshold value by use of a memory unit, the first electrical signal being a signal output from the microphone when the determination unit determines that the imaging unit is in operation, the second electrical signal being a signal output from the microphone when the determination unit determines that the imaging unit is not in operation; and reducing a noise of the electrical signal by use of a noise reduction unit, the electrical signal being output from the microphone using the noise signal stored in the memory unit.

### BRIEF DESCRIPTION OF THE DRAWINGS

Referring now to the attached drawings which form a part of this original disclosure:

FIG. 1 is a schematic block diagram showing a configuration of an imaging apparatus in accordance with an embodiment of the present invention;

FIG. 2A is a flowchart indicating an example of operations of the imaging apparatus of FIG. 1;

FIG. 2B is a schematic diagram of an example showing an output signal from a microphone of the camera in accordance with the embodiment of the present invention in step S104 of FIG. 2A, in which environmental sounds are small enough and the autofocus operations of the camera are not performed;

FIG. 2C is a schematic diagram of an example showing an output signal from a microphone of the camera in accordance with the embodiment of the present invention in step S104 of FIG. 2A, in which environmental sounds are large and the autofocus operations of the camera are not performed;

FIG. 2D is a schematic diagram of an example showing an output signal from a microphone of the camera in accordance with the embodiment of the present invention in step S105 of FIG. 2A, in which environmental sounds are small enough and the autofocus operations of the camera are performed;

FIG. 3 is a schematic diagram of an example showing a signal transition of an autofocus lens as a function of time;

FIG. 4 is a schematic diagram of an example showing a transition of a subtraction factor as a function of time;

FIG. 5 is a schematic diagram of an example showing a recorded sound signal profile; and

FIG. 6 is a schematic diagram of an example showing a signal profile obtained after performing a noise reduction process applied to a recorded sound signal.

### DESCRIPTION OF EMBODIMENTS

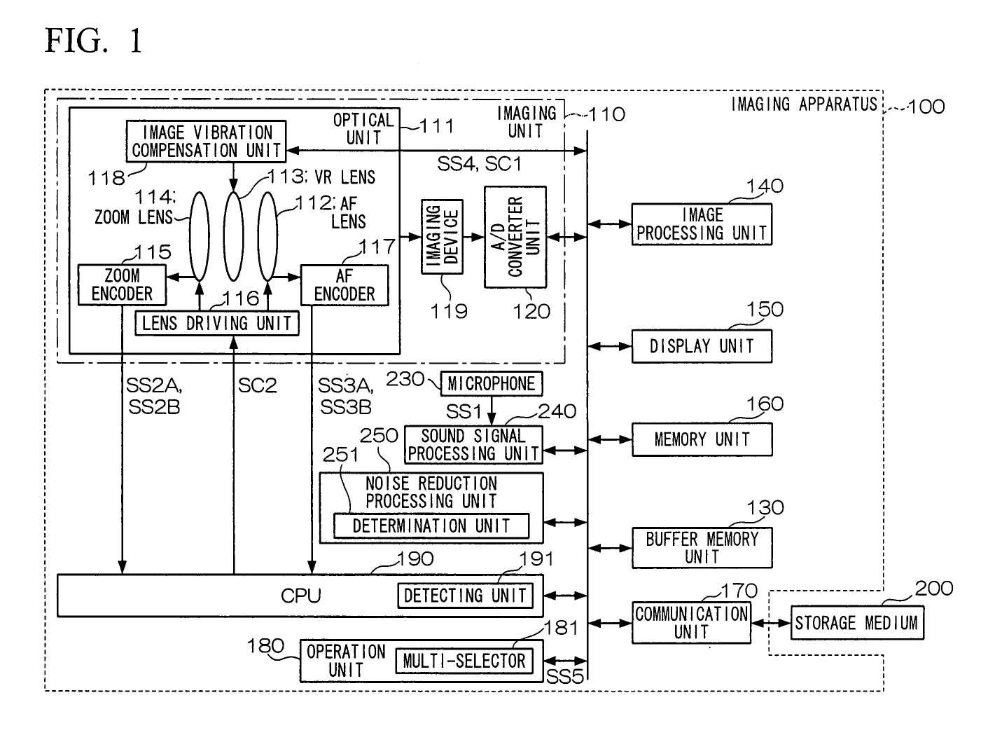

Some embodiments of the present invention will now be described with reference to the drawings. FIG. 1 is a schematic block diagram showing a configuration of an imaging apparatus. An imaging apparatus 100 takes (or performs imaging of) an image of an object by use of an optical unit 111 of an imaging unit 110, and stores the obtained image data in a storage medium 200. Further, the imaging apparatus 100 reduces a noise from a sound signals which is recorded by a microphone 230, and stores the noise reduced sound signal into the storage medium 200. For example, the imaging apparatus 100 is formed by combination of a lens barrel and a camera body.

The imaging apparatus 100 includes an imaging unit 110, an image processing unit 140, a display unit 150, a buffer memory unit 130, an operation unit 180, a memory unit 160, a CUP (Central Processing Unit) 190, a microphone 230, a sound signal processing unit 240 a noise reduction unit 250, and a communication unit 170.

The imaging unit 110 includes an optical unit 111, an imaging device 119, and an A/D (Analog/Digital) converter unit 120. The imaging unit 110 is controlled by the CPU 190 according to setting of imaging conditions such as an iris value, an exposure value or the like. In the imaging unit 110, an optical image is formed on the imaging device 119 through the optical unit 111, and the A/D convertor unit 120 converts the optical image to digital data, so that image data of the optical image is formed.

The optical unit 111 includes a zoom lens 114, a focus adjustment lens (AF lens: auto focus lens) 112, a vibration compensation lens (VR lens: vibration reduction lens) 113, a lens driving unit 116, a zoom encoder 115, an AF encoder 117, and an image vibration compensation unit 118. The optical unit 111 forms a lens barrel. The optical unit 111 introduces an incident light having passed through the zoom lens 114, the AF lens 112 and the VR lens 113 to a light receiving plane of the imaging device 119, and forms an optical image on it. In other ways, the optical unit 111 may be mounted on the imaging apparatus 100 to be integrated with or may be attachable to the imaging apparatus 100.

The zoom encoder 115 is a sensor which detects a driving direction of the zoom lens 114 while imaging pictures and outputs a zoom driving signal to the CPU 190 as a sensor signal SS2A in response to the driving direction. In this case, the zoom driving signal according to the driving direction of the zoom lens 114 may be a signal indicating any one of states where the zoom lens 114 is at a standstill in the optical unit 111, where the zoom lens 114 is being driven in the zoom direction (e.g., a motor, cam or the like rotates in the clockwise (CW) to drive the zoom lens 114) and where the zoom lens 114 is being driven in the wide direction (e.g., the motor, cam or the like rotates in the counter-clockwise (CCW) to drive the zoom lens 114). In other words, to detect the driving direction of the zoom lens 114 may be to detect the rotating direction of the motor, cam or the like that drives the zoom lens 114. Further, the motor, cam or the like for driving the zoom lens 114 may be disposed on the lens driving unit 116. The zoom encoder 115 detects a zoom position indicating a position of the zoom lens 114 in the optical unit 111 base on the detected driving direction and the amount of driving of the zoom lens 114. The zoom encoder 115 also functions as a sensor that outputs the detected position of the zoom lens 114 to the CPU 190 as a sensor signal SS2B.

When taking an image, the AF encoder 117 detects the driving direction of the AF lens 112 and transmits a signal according to the driving direction of the AF lens 112 to the CPU 190 as a sensor signal SS3A. In this case, the signal according to the driving direction of the AF lens 112, the sensor signal SS3A, may indicate a state where the AF lens 112 is at a standstill in the optical unit 111. Further, for example, the signal according to the driving direction of the AF lens 112 may be one of the states where the AF lens 112 is being driven to in the zoom direction (e.g., a motor, cam or the like rotates in the clockwise (CW) to drive the AF lens 112) and where the AF lens 112 is being driven in the wide direction (e.g., the motor, cam or the like rotates in the counter-clockwise (CCW) to drive the AF lens 112). In other words, to detect the driving direction of the AF lens 112 may be detection of the rotation direction of the motor, cam or the like that drives the AF lens 112. Further, the motor, cam or the like that drives the AF lens 112 may be disposed in the lens driving unit 116. The AF encoder 117 also functions as a sensor which detects a focus position indicating the position of the AF lens 112 based on a detected amount of driving of the AF lens 112 in the driving direction and transmits a signal of the focus position to the CPU 190 as a sensor signal SS3B.

The image vibration compensation unit 118 is a sensor which detects vibrations of an image due to the optical unit 111 and transmits the signal of the vibrations to the CPU 190 as a sensor signal SS4 while taking a picture. Further, the image vibration compensation unit 118 drives the VR lens 113 in a direction which compensates the vibrations of the image formed by the optical unit 111 based on a control signal SC1 received from the CPU 190. In this case, the image vibration compensation unit 118 may detect a position of the VR lens 113 and transmits a signal of the position of the VR lens 113 to the CPU 190 as the sensor signal SS4.

The lens driving unit 116 controls the positions of the AF lens 112 and the zoom lens 114 based on the control signal SC2 received from the CPU 190. The lens driving unit 116 includes an actuator unit that is driven for taking pictures. For example, the actuator unit to be driven for taking pictures may be a motor which drives the AF lens 112, the zoom lens 114 or the like. The actuator may be disposed in the imaging apparatus 100 or an optical unit (lens barrel) that is attachable to the imaging apparatus 100.

The imaging device 119 includes an optical-electrical signal conversion plane. The imaging device 119 converts an optical image formed on a light receiving plane of the optical-electrical signal conversion plane into an electrical signal and transmits the electrical signal to the A/D convertor unit 120.

The imaging device 119 stores image data received with instructions of taking images through the operation unit 180 into the storage medium 200 via the A/D convertor unit 120 as a static image or moving images. While the imaging device 119 does not receive the instructions of taking images via the operation unit 180, the imaging device 119 transmits image data being continuously obtained to the CPU 190 and the display unit 150 via the A/D converter unit 120 as through-image data.

The A/D converter unit 120 converts the electrical signals transformed by the imaging device 119 into digital signals. The A/D converter unit 120 transmits image data which are the converted digital signals to the buffer memory unit 130.

The operation unit 180 includes, for example, a power switch, a shutter button, a multi-selector (+key) 181, a zoom key or the other operation parts relevant to the operations of the imaging apparatus. The operation unit 180 is a sensor that receives operation inputs by an operator (user) and transmits a sensor signal SS5 based on the operation inputs to the CPU 190. For example, the operation parts may include a tact switch, a cross key switch or the like, a focus operation ring, a zoom operation ring or the like relevant to operation rings.

The image processing unit 140 performs image processing of the image data temporarily stored in the buffer memory unit 130 with reference to the image processing conditions stored in the memory unit 160. The image data performed by the image processing are stored in the storage medium 200 via the communication unit 170. Further, the image processing unit 140 may execute the image processing for the image data stored in the storage medium 200.

The display unit 150 may be a liquid crystal display, which indicates the image data obtained by the imaging unit 110, a recording condition of driving sound, operation display and the like. Further, when the display unit 150 indicates the recording condition of the driving noise under control of the CPU 190, the display unit 150 can indicate at least one of information corresponding to a threshold value used to determine an estimated noise (noise signal) used to perform a noise reduction process and information corresponding to the noise signal. Descriptions related to the estimated noise will be given later. The display unit 150 may be, for example, an organic electroluminescence (EL) display, an electronic ink display or the like.

The buffer memory unit 130 temporarily stores the image data taken by the imaging unit 110. The buffer memory unit 130 temporarily stores the sound signals corresponding to sounds collected by the microphone 230.

The microphone 230 collects sounds and converts the sound wave of the sounds into electrical signals (analog signals) SS1. The microphone 230 transmits the electrical signal SS1 to the buffer memory unit 130. Namely, the microphone 230 transmits the electrical signals (hereafter, microphone output signal) SS1 to the sound signal processing unit 240 which converts the microphone output signal SS1 to digital signals, and outputs the distal signals to the buffer memory unit 130. In this case, the drive sound generated by the imaging unit 110 may be superimposed on the microphone output signal SS1. The imaging unit 110 is provided to take images formed by the optical unit 111. The imaging unit 110 includes at least any one of the actuator that drives the optical unit 111 at the lens driving unit 116, the image vibration compensation unit 118 or the like and the operation parts that form the operation unit 180 or the like which is operable by an operator. The imaging unit 110 may includes a buffer memory unit 130 which is an image record unit for recording moving pictures, a storage medium 200 or the like.

The memory unit 160 is formed by a nonvolatile memory or the like. For example, the memory unit 160 stores a judging condition that is referred when a scene is determined by the CPU 190, and stores the imaging conditions respectively corresponding to the scenes determined by a scene determination. Further, the memory unit 160 stores the drive sounds collected with the microphone 230 by actually operating the imaging unit 110. The drive sounds stored in the memory unit 160 may be sound wave information or information obtained after performing a predetermined signal processing such as the Fourier transformation for the sound wave information. More specifically, the memory unit 160 stores a microphone output signal SS1 as a noise signal (drive sound) when a signal ratio of a first electrical signal SS1 and a second electrical signal is equal to or greater than a predetermined threshold value, in which the first electrical signal is a microphone output signal SS1 output from the microphone 230 when the determination unit 251 determines that the imaging unit 110 is in operation, and the second electrical signal is a microphone output signal SS1 output from the microphone 230 when the determination unit 251 determines that the imaging unit 110 is not in operation. Furthermore, after storing the noise signal, the memory unit 160 stores a microphone output signal SS1 output from the microphone 230 as a noise signal when the signal ratio of the first electrical signal and the second electrical signal is equal to or greater than the predetermined threshold value, in which the first electrical signal (the microphone output signal SS1) is output from the microphone 230 when the determination unit 251 determines that the imaging unit 110 is in operation, and the second electrical signal (the microphone output signal SS1) is output from the microphone 230 when the determination unit 251 determines that the imaging unit 110 is not in operation.

In the present embodiment, the noise reduction processing unit 250 performs a noise reduction process that reduces the noise signal from the collected sound signal using the spectral subtraction method. The noise reduction processing unit 250 performs Fourier transformation on the collected sound signal to obtain spectral resolution of the sound signal. The noise reduction processing unit 250 subtracts the spectra components of the estimated noise signal from the spectra of the sound signal obtained by the spectral resolution process. The spectral subtraction method is reported in, such as Boll, S. F. “Suppression of Acoustic Noise in Speech Using Spectral Subtraction,” IEEE Trans. Acoust., Speech, Signal Processing, vol. ASSP-27, pp. 113-120, April 1979. In the present embodiment, the drive sound is used as the estimated noise signal for the noise reduction processing.

The sound signal processing unit 240 converts the microphone signal SS1 output from the microphone 230 into digital signals and stores the digital signals in the buffer memory unit 130.

The CPU 190 controls each part of the imaging apparatus 100 by executing a program stored in the memory unit 160. For example, the CPU 190 controls the imaging unit 110 according to predetermined imaging conditions (e.g., iris value, exposure value or the like). The CPU 190 transmits the control signal SC2 to the lens driving unit 116 based on a zoom position signal received from the zoom encoder unit 115, a focus position signal received from the AF encoder unit 117, and an instruction operation signal input from the operation unit 180. The lens driving unit 116 controls the positions of the AF lens 112 and the zoom lens 114 based on the control signal SC2 received from the CPU 190. The control signal SC2 includes plural control signals provided from the CPU 190 to the lens driving unit 116. The control signal SC2 includes, for example, an autofocus driving signal that is used for driving and controlling the AF lens 112 using the lens driving unit 116.

Furthermore, the CPU 190 includes a detecting unit 191. The detecting unit 191 detects at least one of a sensor signal transmitted from a sensor detecting the operation of the imaging unit 110 and the control signal transmitted from the CPU 190 that is a control unit controlling the imaging unit 110. As described above, the imaging unit 110 takes an image using the optical unit 111. Namely, the detecting unit 191 detects a state whether the imaging unit 100 (the zoom lens 114, the VR lens 113, and the AF lens 112) provided in the imaging apparatus 100 is in operation or not and a state whether the operation unit 180 or the like is in operation or not. The detecting unit 191 may detect whether the imaging unit 110 is in operation or not based on a control signal driving the imaging unit 110. Further, the detecting unit 191 may detect a state whether the imaging unit 110 is in operation or not based on a signal indicating that the imaging unit 110 has been operated. The detecting unit 191 transmits detected information indicating whether the imaging unit 110 is in operation or not to the determination unit 251 of the noise reduction unit 250. Specifically, the detecting unit 191 may detect a state of the operation of the imaging unit 110 based on the control signal SC1 transmitted from the CPU 190 to the image vibration compensation unit 118 for driving the VR lens 113, in which the state indicates whether the imaging unit 110 is in operation or not. In other case, the detecting unit 191 may detect the state of the operation of the imaging unit 110 based on the control signal SC2 transmitted from the CPU 190 to the lens driving unit 116 for driving the zoom lens 114 or the AF lens 112. Further, the detecting unit 191 may detect the state of the operation of the imaging unit 110 based on the sensor signal SS2A or the sensor signal SS2B transmitted from the zoom encoder 115. The detecting unit 191 may detect the state of the operation of the imaging unit 110 based on the sensor signal SS3A or the sensor signal SS3B. The detecting unit 191 may detect the state of the operation of the imaging unit 110 based on the sensor signal SS4 transmitted from the image vibration compensation unit 118. Further, the detecting unit 191 may detect the state of the operation of the imaging unit 110 by detecting a state where the operation unit 180 has been operated, based on the sensor signal SS5 transmitted from the operation unit 180.

In the following, descriptions will be given with reference to a noise reduction processing unit 250. The noise reduction processing unit 250 includes a determination unit 251. The noise reduction processing unit 250 may be formed by combination with the CPU 190. Further, the noise reduction processing unit 250 may be included in the CPU 190. Namely, the determination unit 251 determines the state of the operation of the imaging unit 110 by using at least one of a sensor signal detected by the detecting unit 191 and a control signal. In other words, the determination unit 251 determines that the imaging unit 110 is in operation when at least one of states where the actuator for driving the optical unit 111 is in operation and where part of the operation unit 180 is being manipulated is detected. The noise reduction processing unit 250 makes the memory unit 160 store a first microphone output signal SS1 output from the microphone 230 as a noise signal (drive sound) when a signal ratio of the first microphone output signal SS1 and a second microphone output signal SS1 is equal to or greater than a predetermined value, in which the first microphone output signal SS1 is a signal transmitted from the microphone 230 when the determination unit 251 determines that the imaging unit 110 is in operation, and the second microphone output signal SS1 is a signal output from the microphone 230 when the determination unit 251 determines that the imaging unit 110 is not in operation. Further, the noise reduction processing unit 250 includes a function that updates the noise signal after having the memory unit 160 store the noise signal. In other words, the noise reduction processing unit 250 makes the memory unit 160 store a first noise signal, and then the noise reduction processing unit 250 makes the memory unit 160 store the first noise signal as an updated noise signal when the signal ratio of the first microphone output signal SS1 and the second microphone output signal SS1 is equal to or greater than the predetermined value, in which the first microphone output signal SS1 is the first signal output from the microphone 230 when the determination unit 251 determines that the imaging unit 110 is in operation, and the second microphone output signal SS1 is the second signal output from the microphone 230 when the determination unit 251 determines that the imaging unit 110 is not in operation.

Furthermore, when the determination unit 251 determines that any one of units, the optical unit 111, the imaging device 119 or the A/D converter unit 120 is in operation, the noise reduction processing unit 250 uses a noise signal of the determined unit being in operation stored in the memory unit 160 as an estimated noise. The noise reduction processing unit 250 performs a noise reduction processing over the frequency domain based on the spectral subtraction method, so that the noise reduction processing unit 250 reduces noise included in the microphone output signal SS1 output from the microphone 230. Then, the noise reduction processing unit 250 transmits a noise reduced signal of the microphone output signal SS1 to the communication unit 170 as a noise subtraction processed signal (a sound data).

The communication unit 170 is connected to the storage medium 200 attachable to the communication unit 170, and performs read/write/erase of information (image data, noise subtraction processed signal or the like) for the storage unit 200.

The storage medium 200 is a memory unit attachable to connect to the imaging apparatus 100, and stores the image data formed by the imaging unit 110, the noise subtraction processed signal or the like. The storage medium 200 may be integrated with the imaging apparatus 100.

Furthermore, in the following, descriptions will be given for the operations of a noise reduction processing in accordance with the present embodiment. In this case, a drive sound of autofocus will be described as an example of drive sounds caused by the imaging unit 110, in which the drive sound of autofocus corresponds to sounds generated while the AF lens 112 is driven and while the AF lens 112, the lens driving unit 116 or the like is driven.

In this case, the spectral subtraction method uses an estimated noise for setting the amount of subtraction. For the present example, recording of the driving sound of autofocus is performed before the imaging apparatus takes moving pictures (taking pictures with sound), and the estimated noise is obtained based on the recorded sound is used to estimate the estimated noise. For accurate estimation of the estimated noise, it would be desired to record the driving sound in silent circumstances. However, in general, background sound is generated when pictures (images) are taken, and recording of the sound of autofocus is performed while superimposing the background sound. In the present embodiment, when a sound ration of a first sound and a second sound is equal to or greater than a predetermined value, the first sound is used as nose data, in which the first sound is recorded when the AF lens 112 is driven and the second sound is recorded when the AF lens 112 is not driven. In other words, when the drive sound of the AF lens 112 is equal to or greater than the background sound, the drive sound of the AF lens 112 is used as data to estimate the estimated noise data of the drive sound.

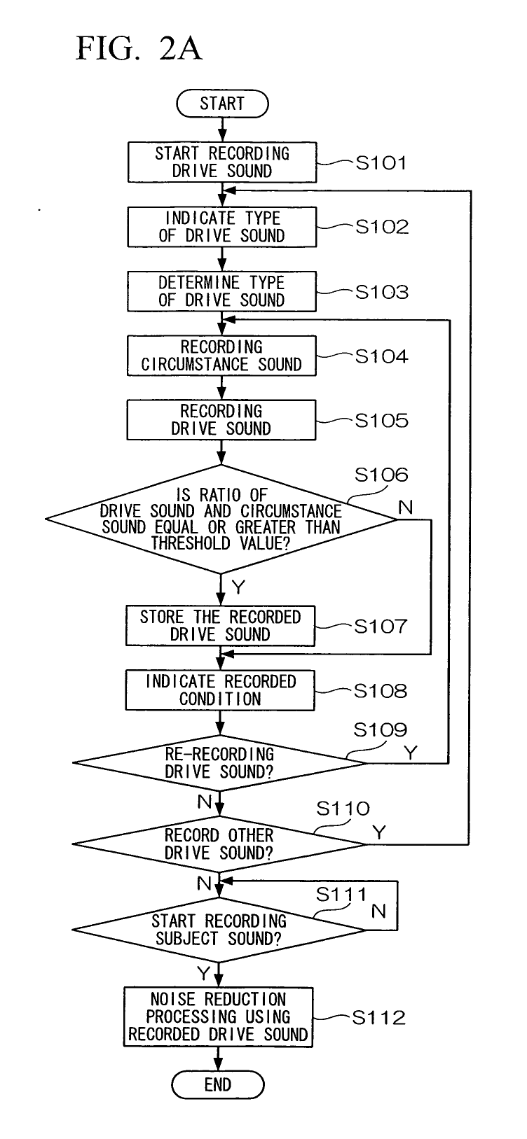

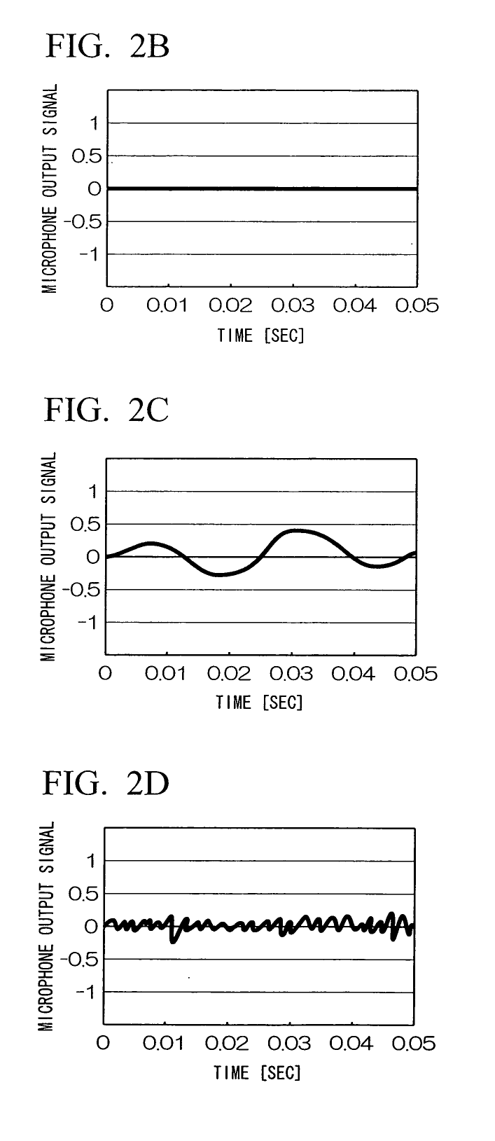

In the following, with reference to FIG. 2A, descriptions will be given for a pre-record processing of autofocus sound and a post-record processing (record processing of a subject sound) including a noise reduction process of moving picture recording performed after the pre-record processing in the imaging apparatus. When the multi-selector 181 of the operation unit 180 is manipulated by an operator and the instructions of recording start of the drive sound is given, the CPU 190 of the imaging apparatus 100 starts the drive sound record processing (indicated in step S101 of FIG. 2A).

In step S102, with being under control of the CPU 190, a type of drive sound of a subject is indicated on the display unit 150. In this case, the type of drive sound is selected in response to the sensor signal SS5 transmitted from the operation unit 180 manipulated by an operator (step S103). The present example shows a case where the autofocus sound is selected.

The sound signal processing unit 240 converts the sound recorded by the microphone 230 into a digital signal, and makes the buffer memory unit 130 store the digital signal for a predetermined period of time as a background sound (step S104). In the recording of the background sound, the CPU 190 stops driving each part of the imaging unit 110. In other words, the autofocus sound is not generated during the recording. For example, FIG. 2B shows an example that indicates a first microphone output signal transmitted from the microphone 230 while recording the background sound, where the background sound is low enough and the autofocus is not driven. The first microphone output signal indicates to be nearly zero level. Further, FIG. 2C shows an example that indicates a second microphone output signal transmitted from the microphone 230 while recording the background sound, where the background sound is high and the autofocus is not driven. The second microphone output signal indicates a sine wave like signal output in around 0.05 seconds. While the recording is being performed, the display unit 150 can indicate a sign indicating that a background sound is being recorded, a warning sign indicating that the operation unit 180 should not be manipulated, or other similar indications. Alternatively, the CPU 190 may preliminary set up a status for rejecting an input signal from the operation unit 180 for a case where the operation unit 180 is manipulated while the background sound is being recorded.

In step S105, the CPU 190 transmits the control signal SC2 to the lens driving unit 116 for driving the AF lens 112 in a predetermined period of time. At the same time, the sound signal processing unit 240 converts the sound recorded by the microphone 230 into a digital signal, and a dataset of the digital signal corresponding to the predetermined period of time is stored in the buffer memory unit 130 as a first autofocus drive sound. As an example of step S105, a signal output from the microphone 230 during recording a sound is indicated in FIG. 2D, in which the microphone 230 is recording the sound under a condition where the background sound is small enough. It indicates that the signal output of the microphone 230 is small, having small vibrations in a short period of time. The signal output corresponds to the autofocus drive sound.

In step S106, the CPU 190 (or the noise reduction processing unit 250 controlled by the CPU 190) calculates a signal ratio between the background sound recorded in step S104 and the autofocus sound (drive sound) recorded in step S105, and determines whether the signal ratio is greater than a predetermined threshold value or not. For example, the signal ratio of the autofocus sound and the background sound may be obtained by dividing an effective value of a signal wave of the drive sound by an effective value of a signal wave of the background sound, or by dividing a peak-to-peak value of the signal wave of the drive sound by a peak-to-peak value of the signal wave of the background sound. The way of obtaining the signal ratio is not limited to the case described above.

Further, the signal ratio is compared to the predetermined threshold value. This make it possible to determine how much greater the drive sound is than the background sound compared to a predetermined multiple.

When the signal ratio of the drive sound and the background sound is greater than the predetermined threshold value, that is, the drive sound is greater than the background sound by the predetermined multiple, the dataset of the drive sound in the buffer memory unit 130 is stored in the memory unit 160 in step S107. On the other hand, when the signal ratio of the drive sound and the background sound is less than the predetermined threshold value, the dataset of the drive sound in the buffer memory unit 130 is not stored in the memory unit 160, which corresponds to a judgment “N” in step S106.

Further, the CPU 190 causes the display unit 150 to indicate a determination result of step S106 and recording conditions in steps S104 and S105. The display unit 150 indicates at least one of information corresponding to a threshold value used to determine an estimated noise (noise signal) when a recording condition of the drive sound is determined and information corresponding to the noise signal. Subsequently, the CPU 190 causes the display unit 150 to indicate information denoting predetermined selectable options and receives operation inputs from the operation unit 180 which is manipulated by a user. Thereby, the CPU 190 determines whether the autofocus sound should be re-recorded or not based on the operation input. When the operation unit 180 indicates re-recording resulted from the manipulation of the user, the process step returns to step S104 and the background sound and the autofocus sound are recorded, which is indicated as “Y” in step S109 and the process returns to S104. When an option of re-recording step S110 is not selected, a determination is made in step S110 whether another drive sound should be recorded or not (“N” in step S109 and the n t the process advances to step S111).

In step S110, the CPU 190 causes the display unit 150 to indicate information denoting predetermined selectable options and receives operation inputs from the operation unit 180 which is manipulated by a user. Thereby, the CPU 190 determines whether other drive sounds should be recorded or not. When the operation unit 180 manipulated by the user indicates that the other drive sounds should be recorded, the process returns to step S102 and a re-selection of a drive sound is made from the other drive sounds, and the selected drive sound is recorded, which is indicated as “Y” in step S110 and the process returns to S120. When the other drive sound is not selected, the process becomes a recording ready state of the subject sound (indicated as “N” in step S110, and the process advances to step S111).

Once predetermined operations are made for the operation unit 180 and a process including recording of a subject sound, such as recording of motion pictures, is started (“Y” in step S111), the noise reduction processing unit 250 performs (step S112), according to a determination result of the determination unit 251 based on an output signal of the detection unit 191, a noise reduction process for a microphone output signal SS1 having been stored in the buffer memory unit 130 via the sound signal processing unit 240.

In the process operations above, when the drive sound is recorded in a state where a background sound being generated is big to the autofocus sound, the estimated noise might include larger errors. In this case, the CPU 190 can make the display unit 150 indicate that the user should re-record the drive sound. Alternatively, when the autofocus sound is recorded in a state where the background sound is low enough, the CPU 190 determines that noise can be estimated accurately, and an indication denoting successful recording of the drive sound can be displayed on it for noticing the user. Accordingly, by informing the user of a recording condition of the drive sound based on a comparison between the autofocus sound and the background sound, it is possible for the user to have an opportunity to know of an accurate estimation noise.

Further, in step S108 of FIG. 2A, the recording condition on the display unit 150 can be indicated by multiple levels. For example, when the recording condition is poor, the condition level is indicated as “0.” When the condition level is excellent, the condition level is indicated as “3.” Also, as the recording condition can be indicated on the display unit 150 with an indicator showing a graph, the user can recognize the recording condition. For example, the level of recording condition can be determined by a ratio of the autofocus sound and the background sound, in which when the background sound is relatively low compared to the autofocus sound, the recording condition is considered to be in good condition, while when the background sound is relatively high compared to the autofocus sound, the recording condition is considered to be in poor condition. The user can determine if he needs to re-record sounds again by watching the present recording condition. Further, when the recording condition is improved, the user can obtain an estimation noise based on the re-recording result, so that the indicator of the recording condition can be updated. The display unit 150 can indicate text information or graphic pattern, for example, AF (autofocus) “3,” VR (vibration reduction) “1,” Zoom “0,” and Mult-selector “2.”

Furthermore, descriptions will be given below for an example of a practical use in accordance with the present embodiment. In the present embodiment, an operator (a user) can preliminary record a drive sound which is potentially generated while recording motion pictures in advance to recording a motion picture of subject. In this case, a subject of the drive sound can be an autofocus sound generated when the AF lens 112 is driven, a vibration compensation sound, a zooming sound and a multi-selector sound (caused by the user's manipulation). The operator can choose a desired recording type in advance to the recording of subject, so that the drive sound such as the autofocus sound can be recorded. In this case, a recording condition of the drive sound is indicated on the display unit and the user can re-record the drive sound if necessary. In the present embodiment, when the drive sound is recorded where the background sound is high, the recording condition is determined to be poor. In such a case, the operator can re-record the drive sound by avoiding the loud background period or by moving to a quiet place.

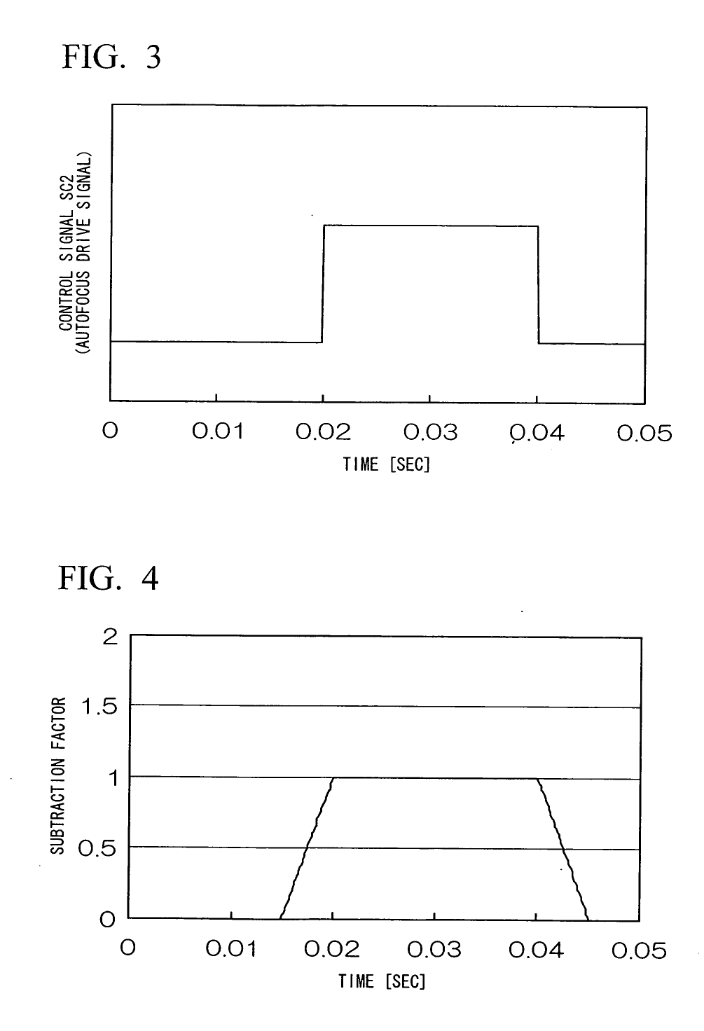

With reference to FIG. 3 through FIG. 6, a way of noise reduction will be described for recording the sound of subject as an example of the AF lens 112 to be driven. When the AF lens 112 is driven, the detecting unit 191 of the CPU 190 detects a state of driving of the AF lens 112 based on a signal output of the control signal SC2 generated by executing an autofocus driving command of the CPU 190, or a signal output of the output sensor signal SS3A of the AF encoder 117, the output sensor signal SS3B of the AF encoder 117 or the like. The detecting unit 191 of the CPU 190 transmits a signal of information indicating the state (being operated) of driving of the AF lens 112 to the determination unit 251 of the noise reduction processing unit 250. The determination unit 251 determines that the AF lens 112 is operating based on the signal received from the detecting unit 191. The noise reduction processing unit 250 performs a noise reduction process for a microphone output signal SS1 in the frequency domain by use of the spectral subtraction method based on a determination result of the determination unit 251, in which the spectral subtraction method uses the autofocus sound stored in the memory unit 160 as the estimated noise. Thereby, the noise reduction processing unit 250 reduces the noise included in the microphone output signal SS1 output from the microphone 230. Further, the noise reduction processing unit 250 stores the microphone output signal SS1 which the noise is reduced in the storage medium 200 via the communication unit 170 as a noise subtraction processed signal.

In this case, the noise reduction process of the noise reduction processing unit 250 may modify a portion of a signal profile gradually for reducing discontinuity of the portion where the microphone output signal SS1 to be executed by the noise reduction process and an original microphone output signal SS1 which the noise is not reduced are connected. FIG. 3 is an illustration indicating a time dependent profile of the control signal SC2 (autofocus drive signal). FIG. 4 is an illustration indicating a time dependent profile of a subtraction factor in a time range identical to that of FIG. 3. In this case, for FIGS. 3 and 4, the time dependent profiles of the control signal SC2 and the subtraction factor are simplified and schematically drawn for clearly explaining time charts of the autofocus sound being generated and the signal profile of the control signal SC2. Thus, the indicated signal profiles and time ranges are different from the real cases.

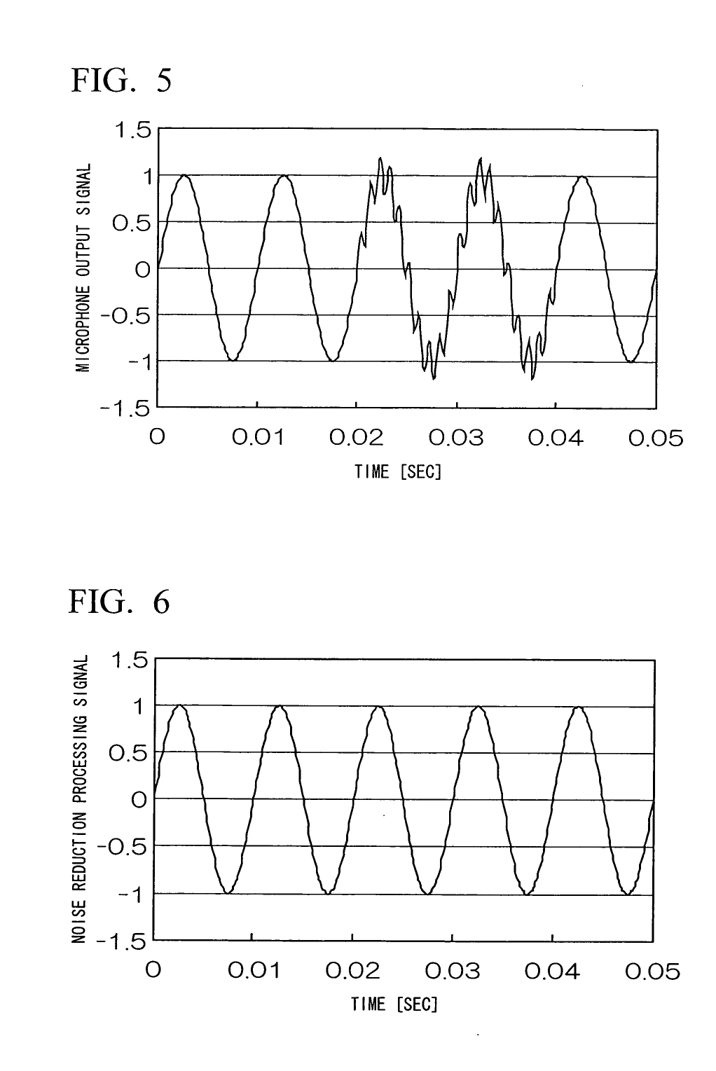

FIG. 5 is a schematic diagram of an example showing a recorded sound signal profile, and FIG. 6 is a schematic diagram of an example showing a signal profile obtained after performing a noise reduction process applied to a recorded sound signal. As is seen in FIG. 5, the noise reduction process can reduce the noise in a sound signal by use of a sound data recorded by actually driving the AF lens 112 even when the noise generated by the AF lens 112 is superposed on the sound signal.

Further, in the embodiment described above, an autofocus sound is recorded in advance to recording a motion picture. Alternatively, the autofocus sound may be recorded after recording the motion picture. In such a case, the noise reduction process is performed after recording the autofocus sound, so that the noise reduction process reduces the autofocus sound from the motion picture containing the autofocus sound. This process may be performed in the imaging apparatus 100 or in a PC (personal computer) to which the sound data is transmitted. For example, the PC can include an input unit which receives from at least one of signal groups of the sensor signals SS2A, SS2B, SS3A, SS3B, SS4, SS5 and the control signals SC1, SC2 or the like, and receives the microphone output signal SS1 and a sound signal converted from the microphone output signal SS1 by digital conversion. The sensor signals SS2A, SS2B, SS3A, SS3B, SS4, and SS5 are transmitted from the zoom encoder 115 detecting the state of operations of the imaging unit 110 which takes an image formed by the optical unit 111 of the imaging apparatus 100, the AF encoder 117, the image vibration compensation unit 118 or the operation unit 180. The control signals SC1 and SC2 are transmitted from the CPU 190 of the imaging unit 110, and the microphone output signal SS1 is transmitted from the imaging apparatus 100. The PC can include a determination unit which determines a state of operations of the imaging unit 110 based on the sensor signals SS2A, SS2B, SS3A, SS3B, SS4 and SS5 or based on the control signals SC1 and SC2. Further, the PC can include a memory unit which stores a first sound signal as a noise signal when a signal ratio of the first sound signal and a second sound signal is equal to or greater than a threshold value, in which the first sound signal corresponds to a sound signal output from an input part (microphone or the like) for a period of time while the determination unit determines that the imaging unit 110 is in operation, and the second sound signal corresponds a sound signal output from the input part for a period of time while the determination unit determines that the imaging unit 110 is not in operation. The PC can include a noise reduction unit which reduces the noise of the sound signal input from the input unit by use of the noise signal stored in the memory unit.

Further, the noise reduction process may be performed when the motion picture is played. In this case, a period of time while the autofocus is driven can be estimated by comparing between the recorded sound data of subject and the estimated noise of the autofocus sound. A noise reduction process following the estimation of the period can be performed in a way identical to that described above.

Further, the microphone 230 to be used may be a microphone provided in the imaging apparatus 100, or a microphone externally provided out of the imaging apparatus 100. When an external microphone is used, it is desirable that a drive sound is recorded with the identical microphone used and set up in the same way as taking motion pictures using the imaging apparatus 100.

In the embodiment described above, although it is indicated that the setting of estimated noise is performed by recording a sound data in response to operations by a user independently from actual picture taking, the setting of estimated noise may be automatically performed without instructions of the user. It is also possible to establish the estimated noise based on a sound data recorded while the imaging unit 110 is in operation during actual imaging and a sound data recorded while the imaging unit 110 is not in operation during actual imaging. For example, when a signal ratio between a first microphone output signal SS1 and a second microphone output signal SS1 is equal to or greater than a predetermined threshold value, the first microphone output signal SS1 is stored as a noise signal, in which the first microphone output signal SS1 is determined by the detecting unit 191 that a first imaging operation includes a condition change while a first picture is being taken by the imaging unit 110 and the second microphone output signal SS1 is determined by the detecting unit 191 that a second imaging operation does not include a condition change while a second picture is being taken. Furthermore, when a third microphone output signal SS1 is recorded for a case where the second imaging operation following the first imaging operation performed by the imaging unit 110 is determined to include a condition change, the noise reduction process can be performed for the third microphone output signal SS1 based on the stored noise signal.

Further, the estimated noise that is established based on the sound data recorded during actual imaging may be updated by another data having a better recording condition. Furthermore, a fourth microphone output signal SS1 is recorded for a case where the third imaging operation following the first imaging operation performed by the imaging unit 110 is determined to include a condition change, and a fifth microphone output signal SS1 is recorded for a case where the imaging operation is determined to include no condition change. Then a first ration between the fourth microphone output signal SS1 and the fifth microphone output signal SS1 is calculated. Further, a first microphone output signal SS1 is recorded for a case where the first imaging operation is determined to include a condition change, and a second microphone output signal SS1 is recorded while it is determined to include no condition change. A second ratio between the first microphone output signal SS1 and the second microphone output signal SS1 is calculated. A fourth microphone output signal SS1 is recorded for a case where the third imaging operation is determined to include a condition change. When the first ratio is greater than the second ratio, the noise signal can be replaced by the fourth microphone output signal SS1.

A first microphone output signal SS1 is recorded for a case where it is determined that an imaging operation condition is changed, a second microphone output signal SS1 is recorded for a case where it is determined that imaging operation conditions are not changed, and a third ratio between the first microphone output signal SS1 and the second microphone output signal SS1 is calculated. Then, the calculations of the ratios and the replacement of the noise signal may be performed for a restricted case where the third ratio is smaller than a predetermined threshold value.

Furthermore, for example, the estimated noise established based on the sound data recorded during actual imaging may be re-established or updated in response to receiving a signal indicating that the optical unit 111 is exchanged or the microphone 230 is exchanged.

Further, when pictures being taken by the imaging unit 110 are continuously indicated on the display unit 150 and operations are not performed for the operation unit 180 for recording the pictures taken by the imaging unit 110, this may be determined to be a state where the first imaging operation is being performed.

Further, a microphone output signal SS1 recorded by the microphone 230 may be associated with a determination result determined by the determination unit 251, and the microphone output signal SS1 and the determination result may be recorded in the storage medium 200 according to the association.

Furthermore, plural noise signals recorded in advance to shipment of products may be stored in the memory unit 160 as plural types of estimated noises. The plural types of estimated noises can be indicated on the display unit 150. A desired noise data can be chosen by a user and a standard noise reduction process can be performed based on the noise data.

A drive sound such as a motor noise of a camera is potentially changed between shipment and after shipment due to aging change, ambient temperature or the like. Further, the drive sound is changed when a detachable lens of a camera is exchanged to a different type of lens. Even if the same type of lens is used, different drive sounds can be generated due to individual differences. In a case of a camera with attachable lenses, it is possible that the drive sound of a new lens product to be sold for the camera is not have been recorded in the camera. In either case, a noise reduction process can be performed based on optimum estimated noises established in accordance with the present embodiment, the noise reduction process.

The function of the CPU 190, the detecting unit 190, the determination unit 251 and the noise reduction processing unit 250 in FIG. 1 may be stored in a computer readable recording medium as a program. The computer-readable recording medium recording the program which causes a computer system to execute instructions for processing of the CPU 190, the detecting unit 191, the determination unit 251 or the noise reduction processing unit 250. In this case, a “computer system” includes an operation system and hardware such as peripheral apparatuses.

Further, the “computer system” includes a home page providing environment (or displaying environment) when the computer system uses WWW (world wide web) network system. Further, the “computer-readable recording medium” includes transmission lines such as networks of the internet, telephone lines which can temporary store programs on the lines and transmit the programs through the lines. In such a case, the “computer-readable recording medium” also includes volatile memories included in computer systems used for a server or a client which can temporary store the program.

Also, the “computer-readable recording medium” includes a carriable medium such as a flexible disk, a magneto-optical disk, a ROM (read only memory), and a CD-ROM, and a storage device such as a hard drive included in the computer system. It will be apparent to those skilled in the art from this disclosure that the following descriptions of the embodiments of the present invention are provided for illustration only and not for the purpose of limiting the invention as defined by the appended claims and their equivalents. In this case, the program described above may be a part which achieves part of the function described above, or the program may be combined with a program already installed in the computer system and achieve the functions described above.

Although the embodiments in accordance with the present invention have been described in detail above with reference to drawings, specific constructions are not limited to those of the embodiments, further modification of design can be made without departing from the scope of the present invention.

Furthermore, the constructions described above with reference numbers may be modified as needed, so that at least a part of the constructions may be replaced with another part.

1-10. (canceled)

11. An imaging apparatus comprising:
a microphone that converts a sound signal into an electrical signal;
a detector that detects at least one of a sensor signal output from an operation sensor detecting an operation of an imaging unit that takes an optical image obtained by an optical unit and a control signal output from an operation unit that controls the operation of the imaging unit;
a determination unit that determines a state of operation of the imaging unit based on at least one of the sensor signal and the control signal;
a memory unit that stores a first electrical signal output from the microphone as a noise signal when a signal ratio of the first electrical signal and a second electrical signal is equal to or greater than a predetermined threshold value, the first electrical signal being a signal output from the microphone when the determination unit determines that the imaging unit is in operation, the second electrical signal being a signal output from the microphone when the determination unit determines that the imaging unit is not in operation; and
a noise reduction unit that reduces a noise of the electrical signal output from the microphone using the noise signal stored in the memory unit.

12. The imaging apparatus as claimed in claim 11, wherein the noise reduction unit reduces a noise of the first electrical signal being the signal output from the microphone when the determination unit determines that the imaging unit is in operation using the noise signal.

13. The imaging apparatus as claimed in claim 11, wherein the imaging unit comprises at least one of an actuator that drives the optical unit and an operation unit.

14. The imaging apparatus as claimed in claim 13, wherein the determination unit determines that the imaging unit is in operation when at least one of cases of detecting of the actuator being driven and of detecting of the operation unit being operated.

15. The imaging apparatus as claimed in clam 13, wherein the imaging unit comprises a motion picture recording unit that records a motion picture.

16. The imaging apparatus as claimed in claim 11, wherein the memory unit stores the first electrical signal as a second noise signal when the signal ratio between the first electrical signal and the second electrical signal is equal to or greater than the predetermined threshold value, the first electrical signal is output from the microphone after the noise signal is stored, and the second electrical signal is output from the microphone after the noise signal is stored.

17. The imaging apparatus as claimed in claim 11, further comprising:
a display unit that indicates at least one of information corresponding to the predetermined threshold ratio and information corresponding to the noise signal.

18. The imaging apparatus as claimed in claim 13, wherein the operation unit that enables an operator to operate the operation unit.

19. A signal processing apparatus comprising:
a signal input unit that inputs at least one of a sensor signal output from a sensor that detects an operation of an imaging unit taking an image obtained by an optical unit of an imaging apparatus and a control signal output from a control unit that controls the operation of the imaging unit, and inputs a sound signal output from the imaging apparatus;
a determination unit that determines a state of operation of the imaging unit using at least one of the sensor signal and the control signal;
a memory unit that stores a first sound signal output from the microphone as a noise signal when a signal ratio of the first sound signal and a second sound signal is equal to or greater than a predetermined threshold value, the first sound signal being output from the microphone while the determination unit determines that the imaging unit is in operation, the second sound signal being output from the microphone while the determination unit determines that the imaging unit is not being operated;
a noise reduction unit that reduces a noise of the sound signal input into the signal input unit using the noise signal stored in the memory unit.

20. The signal processing apparatus as claimed in claim 19, wherein the noise reduction unit reduces a noise of the first sound signal using the noise signal.

21. The signal processing apparatus as claimed in claim 19, wherein the determination unit determines that the imaging unit is in operation in at least one of cases of detecting of an actuator being driven and of detecting of an operation unit being operated.

22. The signal processing apparatus as claimed in claim 19, wherein the memory unit stores the first sound signal as a second noise signal when the signal ratio between the first electrical signal and the second sound signal is equal to or greater than the predetermined threshold value, the first sound signal is output from the microphone after the noise signal is stored, and the second sound signal is output from the microphone after the noise signal is stored.

23. The signal processing apparatus as claimed in claim 21, wherein the signal processing apparatus comprises a motion picture recording unit that records a motion picture.

24. The signal processing apparatus as claimed in claim 21, wherein the operation unit that enables an operator to operate the operation unit.

25. A computer-readable recording medium recording a program which causes a computer to execute instructions for processing signals, the program comprising:
converting a sound signal into an electrical signal by use of a microphone;
detecting at least one of a sensor signal output from an operation sensor detecting an operation of an imaging unit that takes an optical image obtained by an optical unit and a control signal output from an operation unit that controls the operation of the imaging unit by use of a detector;
determining a state of operation of the imaging unit based on at least one of the sensor signal and the control signal by use of a determination unit;
storing a first electrical signal output from the microphone as a noise signal when a signal ratio of the first electrical signal and a second electrical signal is equal to or greater than a predetermined threshold value by use of a memory unit, the first electrical signal being a signal output from the microphone when the determination unit determines that the imaging unit is in operation, the second electrical signal being a signal output from the microphone when the determination unit determines that the imaging unit is not in operation; and
reducing a noise of the electrical signal by use of a noise reduction unit, the electrical signal being output from the microphone using the noise signal stored in the memory unit.

26. The computer-readable recording medium as claimed in claim 25, wherein the step of reducing the noise reduces a noise of the first electrical signal using the noise signal.

27. The computer-readable recording medium as claimed in claim 25, wherein said determining of the state of operation determines that the imaging unit is in operation when at least one of cases of detecting of the actuator being driven and of detecting of the operation unit being operated.

28. The computer-readable recording medium as claimed in claim 25, wherein said storing stores the first electrical signal as a second noise signal when the signal ratio between the first electrical signal and the second electrical signal is equal to or greater than the predetermined threshold value, the first electrical signal being output from the microphone after the noise signal is stored, the second electrical signal being output from the microphone after the noise signal is stored.
